(19) United States
(12) Patent Application Publication
(10) Pub. No.: US 2025/0172008 A1
(43) Pub. Date: May 29, 2025

(54) UTILITY TOWER TOP UPGRADE SYSTEM AND METHOD

(71) Applicant: AMPJACK INDUSTRIES LTD., Winnipeg (CA)

(72) Inventors: Luke CHAPUT, Winnipeg (CA); Nathan STAHL, Winnipeg (CA)

(21) Appl. No.: 19/036,617

(22) Filed: Jan. 24, 2025

Related U.S. Application Data
(63) Continuation-in-part of application No. 18/916,448, filed on Oct. 15, 2024.
Application No. 18/916,448 is a continuation-in-part of application No. 18/749,068, filed on Jun. 20, 2024.
(60) Provisional application No. 63/522,257, filed on Jun. 21, 2023.

(51) Int. Cl. E04H 12/34; E04H 12/10; H02G 1/04

(52) U.S. Cl. CPC E04H 12/34; E04H 12/10; H02G 1/04

(57) ABSTRACT

An electrical utility upgrade system and method for an existing transmission tower having a foundation, a tower structure and an electrical circuit. The upgrade system includes an exoskeleton structure coupled the existing tower structure and secured to the foundation. The system also includes a new tower top that is secure to the tower frame and includes a portion that extends above the existing tower cross arm. Forces acting on the new tower top are transmitted through the exoskeleton structure. The method includes adding the new tower top section and removing the existing tower cross arm and securing the existing or new conductors to the new tower top. The system is design to transfer forces exerted on the tower through the exoskeleton structure and to the foundation to reduce forces acting on the tower structure.

### PRIORITY CLAIM

This application claims priority under 35 U.S.C. § 119 (e) to U.S. application Ser. No. 18/916,448 filed Oct. 15, 2024, which claims priority to U.S. application Ser. No. 18/749,068 filed Jun. 20, 2024, which claims priority from U.S. Provisional Application Ser. No. 63/522,257 filed Jun. 21, 2023, which are expressly incorporated herein by reference in their entirety.

### FIELD OF THE DISCLOSURE

The present disclosure relates generally to the electric utility industry, and more specifically to upgrades the electric utility grid.

### BACKGROUND

The electric utility grid may be the weakest link in the chain connecting the U.S., Canada and other countries to a clean energy future. Seventy percent of the utility grid transmission lines and power transformers in numerous countries are well over 25 years old. There is also insufficient transmission capacity, especially transmission that facilitates transfer of power across regions. Strengthening the grid to support the decarbonization of a country's electricity system will take hundreds of billions of dollars of new investment.

Financial investment alone will not be enough. It will also require a rapid evolution of the regulatory structures that determine how high-voltage transmission lines are to be built using existing technology. Complicated regulatory issues include how to site the lines using existing technology without running roughshod over landowner rights or harming the environment, how to speed up the construction process, and how to determine who should cover the costs. Traditional energy producers are now under strain from a combination of constantly rising electricity demand, aging production and transmission infrastructure. In view of the regulatory, right of way, and cost constraints, a better system and method is needed to rapidly improve the utility grid.

### SUMMARY

The present disclosure may comprise one or more of the following features and combinations thereof.

In illustrative embodiments, the present disclosure is directed to an electrical transmission tower upgrade and method for existing towers in a transmission line route. The utility transmission tower upgrade allows to accommodate additional sub conductors per phase (bundled conductor) to increase the current carrying capabilities of the line.

In illustrative embodiments, the present disclosure the electrical transmission tower upgrade allows for increased phase to tower spacing, at least a 5 ft height increase for phase to ground clearance betterment and ready for installation of Double/Triple Conductor/Phases for capacity upgrade.

In illustrative embodiments, the transmission tower upgrade and method utilizes existing transmission line and structural support and the tower foundation footprint. The transmission tower upgrade system includes a structural exoskeleton that is an external structural skeleton that is coupled to the existing tower structure to support the loading of the additional conductors and phases for capacity upgrade as well as the additional tower structure.

In illustrative embodiments, the method includes feasibility study, condition assessment, and detailed design and analysis. The method includes evaluating the existing structure configurations to determine applicability for adding additional conductors. It also includes field evaluation on the condition of existing structures as well as ground line and transitional zones of existing foundations. It further includes the detailed design and analysis phase builds.

These and other features of the present disclosure will become more apparent from the following description of the illustrative embodiments.

### BRIEF DESCRIPTION OF THE DRAWINGS

FIG. 1 is a perspective view of an existing single conductor and single phase lattice type transmission tower having a tower window for the center conductor, the existing tower design may not include enough clearance from wire conductor to tower steel to prevent circuit trips when birds of prey sit and takeoff from the tower bridge perching area (bird scat stream issue), the existing tower structure and/or foundation also do not have enough capacity to accommodate additional sub conductors per phase (bundled conductor) to increase the current carrying capabilities of the line;

FIG. 2 is a perspective view of an improved tower having a new tower top (shown in green) secured to the existing tower and the circled locations showing new exoskeleton reinforcement members installed as shown in yellow to transfer loads from the new tower top to the foundation;

FIG. 3 is a perspective view of the improved tower having the new tower top (shown in green) secured to the existing tower and showing including new x-bracing installed below the existing crossarm shown in the circled region;

FIG. 4 is a perspective view of the improved tower showing the middle electric circuit being detached from the original bridge and temporarily hung from the tower top while the original center bridge portion is removed and also showing the outer phases being temporarily hung from temporary exoskeleton members installed at the wing ends of the original bridge to support the outer phases during construction;

FIG. 5 is a perspective view of the improved tower showing the middle circuit moved from the temporary attachment to the new v-string insulator and also shows the installation of temporary exoskeleton bracing (shown by the arrows) to support tower loads during lattice upgrades shown in purple;

FIG. 6 is a perspective view of the improved tower showing the removal of original lattice members and replaced with new exoskeleton bracing, shown in blue, which form part of the tower opening;

FIG. 7 is a perspective view of the improved tower showing the outside phases being moved from the original cross arm to the new cross arm of the new tower top;

FIG. 8 is a perspective view of the improved tower showing the step of removing the remaining portions of the original cross arm from the tower;

FIG. 9 is a perspective view of the improved tower showing the step of installing exoskeleton bracing adjacent the new cross arms for the outer circuits; and

FIG. 10 is a perspective view of the improved tower showing increased phase to tower spacing, and height increase for phase to ground clearance betterment and ready for installation of double or triple conductor phases for upgraded utility capacity.

### DETAILED DESCRIPTION

For the purposes of promoting an understanding of the principles of the disclosure, reference will now be made to a number of illustrative embodiments illustrated in the drawings and specific language will be used to describe the same.

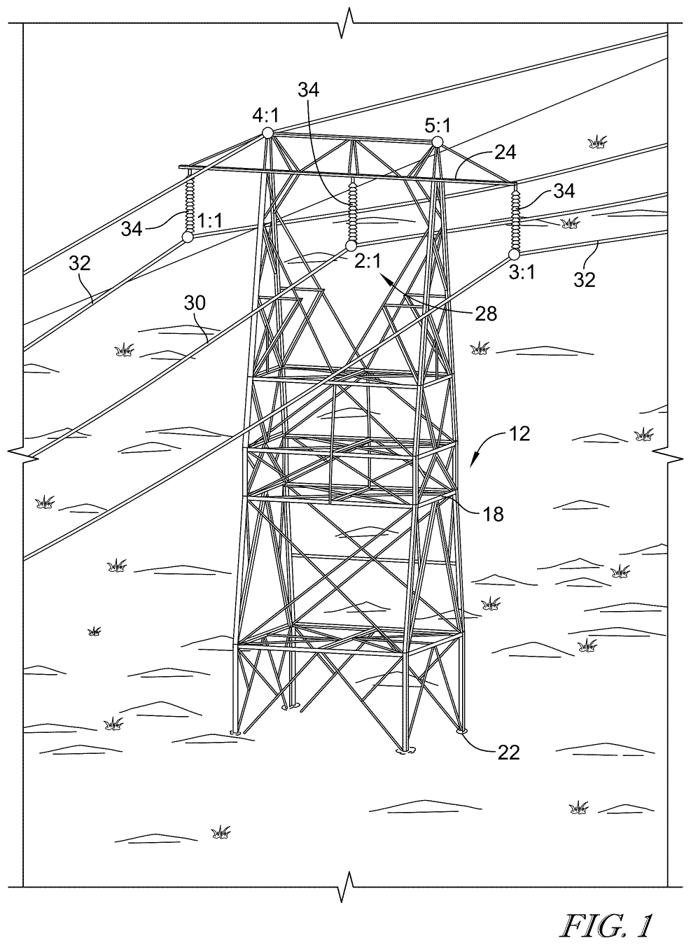

An electrical transmission tower upgrade and method is shown in FIG. 1. Transmission tower system 10 is configured for use in connection with electrical transmission towers 12 used in the electrical power industry to add additional circuits to an existing tower structure.

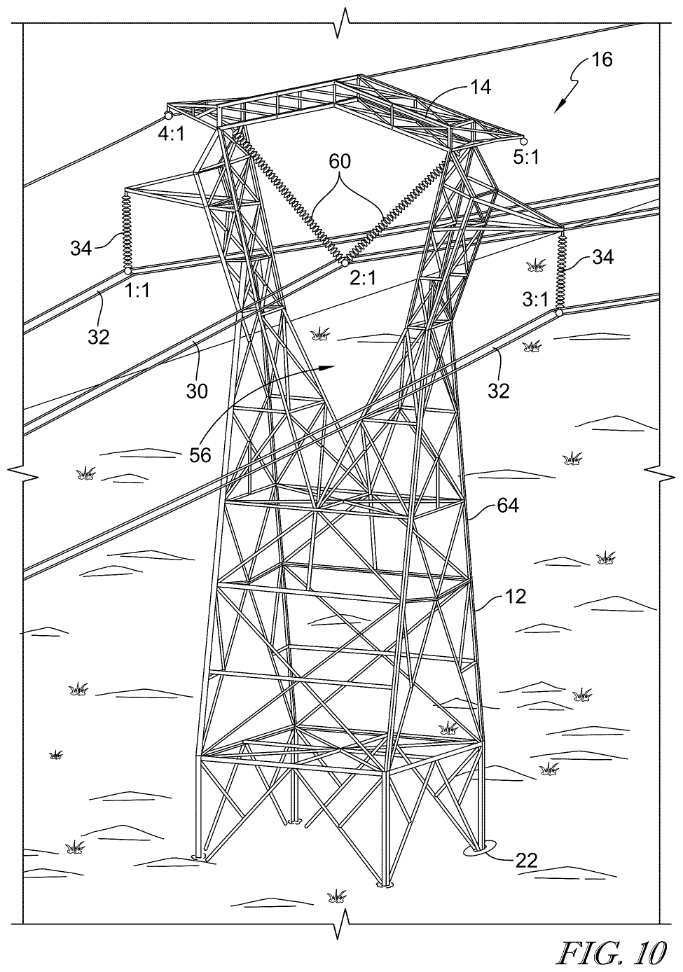

In illustrative embodiments, a utility can add a new tower top 14 to almost any tower 12. FIG. 10 illustrates an upgraded tower 16 that can handle double or triple conductors or phases for capacity upgrade. The systems utility can be used for complete system upgrades by doubling or more the capacity of the existing line. As part of the method, the structures and foundations of the existing utility towers 12 undergo analysis and structural upgrades and then a new tower top 14 would be installed to replace the original cross arm 18 and then new conductors would be strung in. The costs of the system and method would be less than building a completely new line but eliminates or significantly reduces the time and expense of trying to obtain new right of ways and permits for new lines. The proposed system and method is a sustainable solution to obtaining more capacity out of an existing grid.

FIG. 1 is a perspective view of an existing single conductor and single phase lattice type transmission tower 12 having a tower window 28 for a center conductor 30, the existing tower design may not include enough clearance from wire conductor to the tower 12 to prevent circuit trips when birds of prey sit and takeoff from the tower bridge perching area (bird scat stream issue), the existing tower structure 18 and/or foundation 22 also do not have enough capacity to accommodate additional sub conductors per phase (bundled conductor) to increase the current carrying capabilities of the line. Also shown are outer conductors 32 along with the center conductor 30 are all suspended from the original cross arm 24. Center and outer conductors 30, 32 are suspended from the original cross arm 24 by a series of insulators 34.

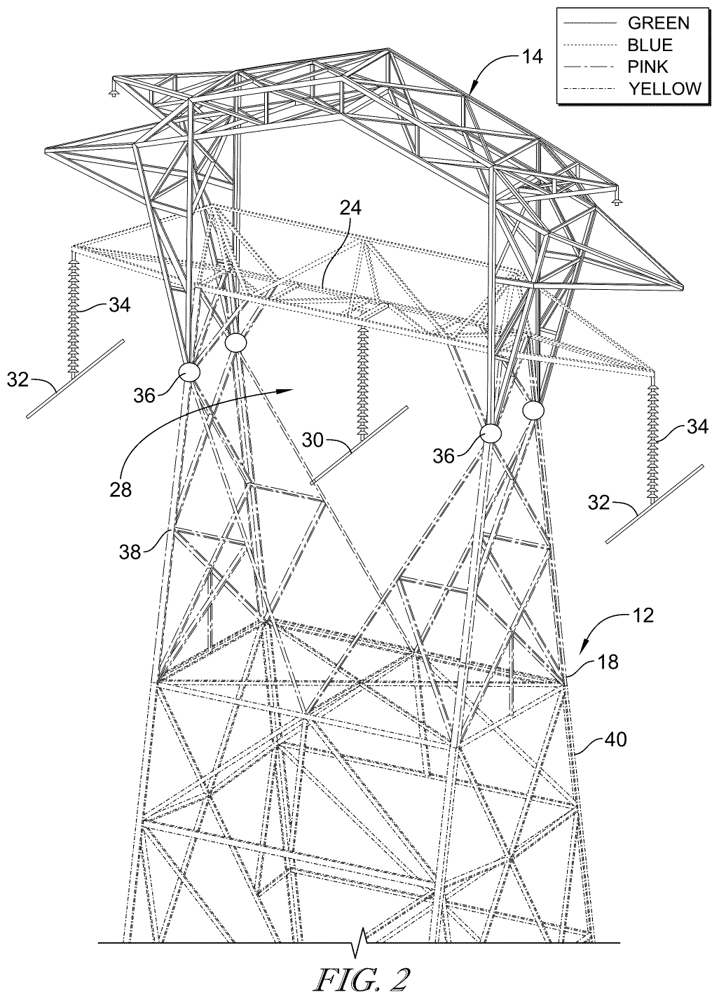

FIG. 2 is a perspective view of an improved tower having a new tower top 14 secured to the existing tower structure 18 and the circle locations 36 showing new exoskeleton reinforcement members 38 installed to reinforce lower section of window 28 and lower exoskeleton reinforcement member 40 to transfer loads from the new tower top to the foundation 22;

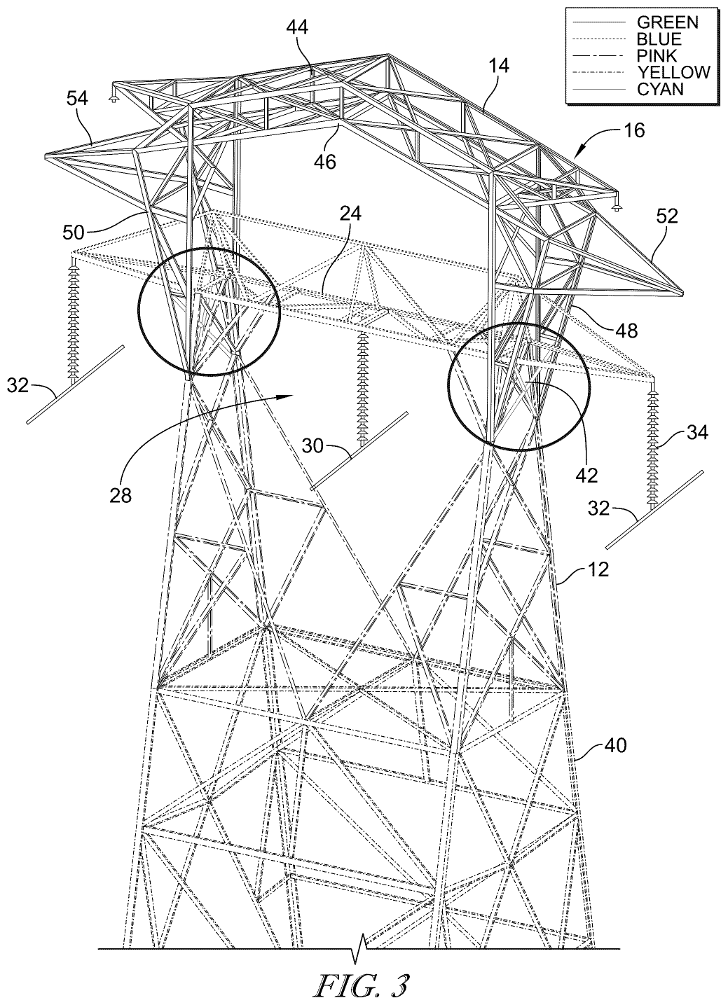

FIG. 3 is a perspective view of the upgraded tower 16 having the new tower top 14 secured to the existing tower structure 18 and showing new x-bracing 42 installed below the original crossarm 24 shown in the circled region. The new tower top 14 includes an inverted v-bridge 44 having a center apex 46 and right and left shoulders 48, 50 that connect the bridge 44 to the existing tower structure 18. The right and left shoulders 48, 50 each including an arm 52, 54, that will be used to secure the outer conductors 32.

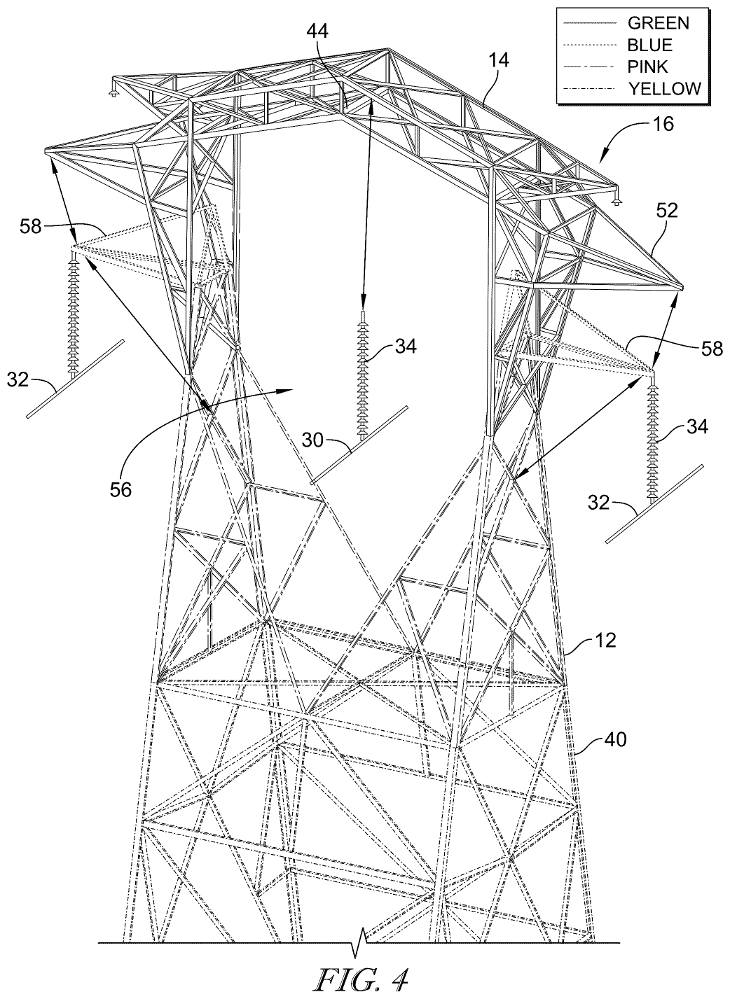

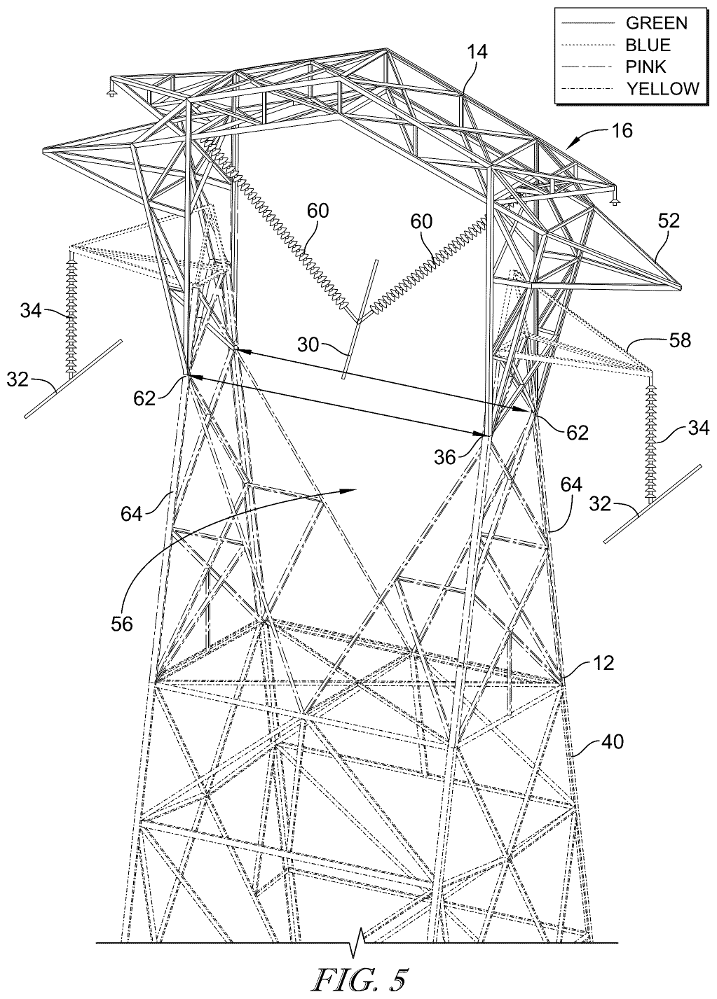

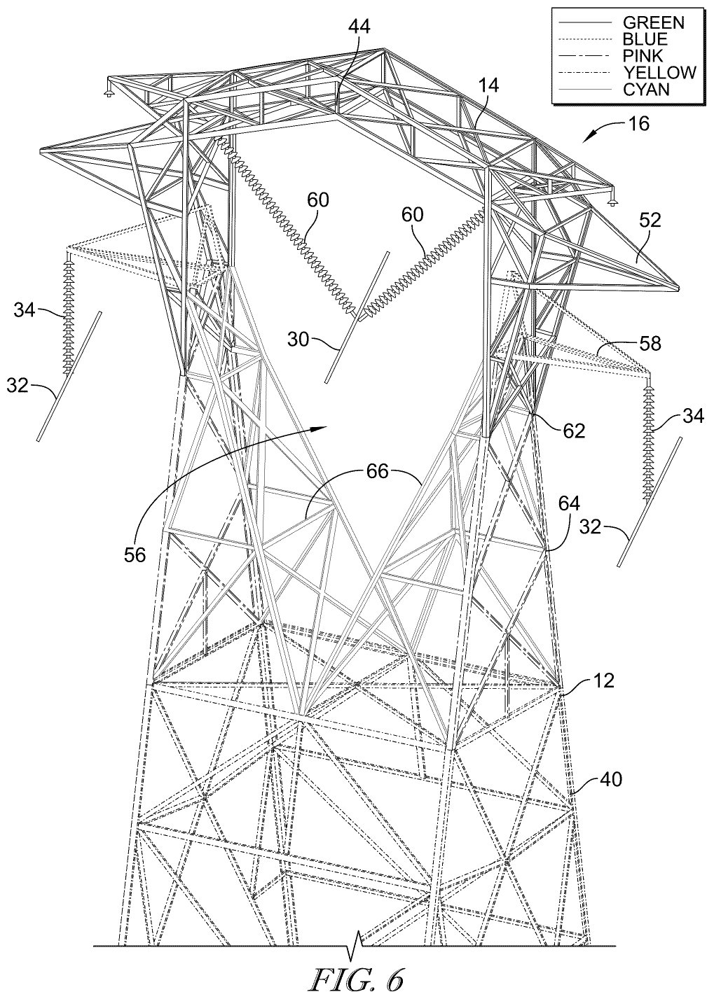

FIG. 4 is a perspective view of the upgraded tower 16 showing the center section of the original cross arm 24 removed and the center conductor 30 being detached and temporarily hung from the tower top 14. The outer conductors 32 are temporarily hung and supported from temporary exoskeleton members installed at the wing ends 58 of the original cross arm or bridge 24 to support the outer conductors 32 during construction. With the center portion of the original cross arm 24 removed, an enlarged window 56 is created. FIG. 5 is a perspective view of the improved tower showing the center conductor 30 moved from the temporary attachment to the new v-string insulator 60 and shows the installation of temporary exoskeleton bracing 62 (shown by the arrows) to support tower loads during lattice upgrades 64 shown in yellow. FIG. 6 is a perspective view of the upgraded tower 16 showing the removal of original lattice members and replaced with new exoskeleton bracing 66, shown in cyan, which form part of the tower window 56.

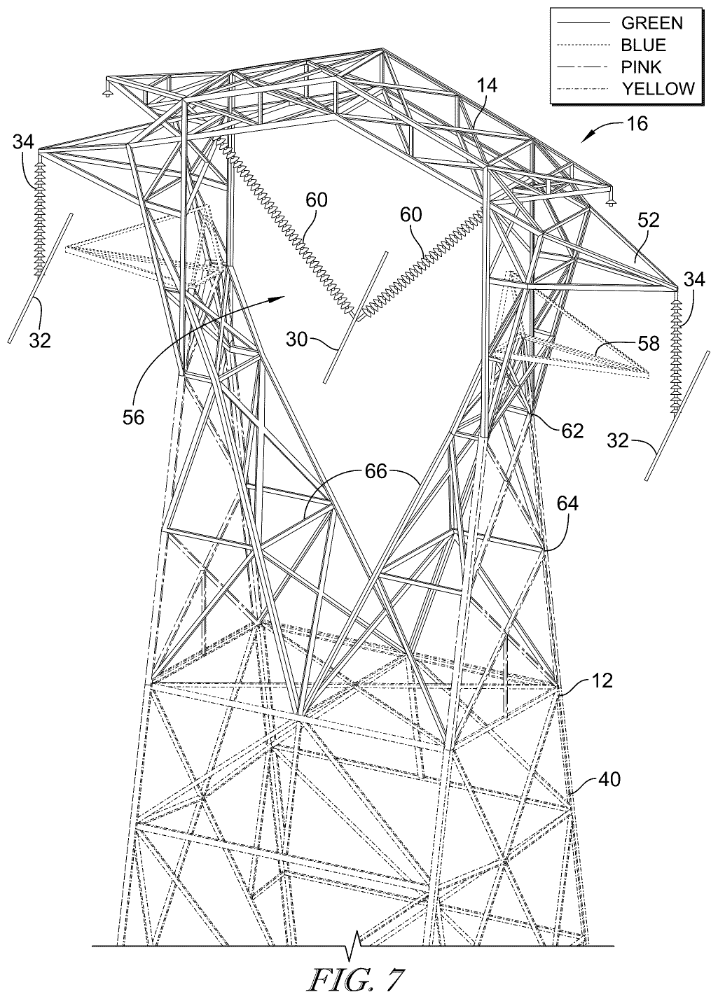

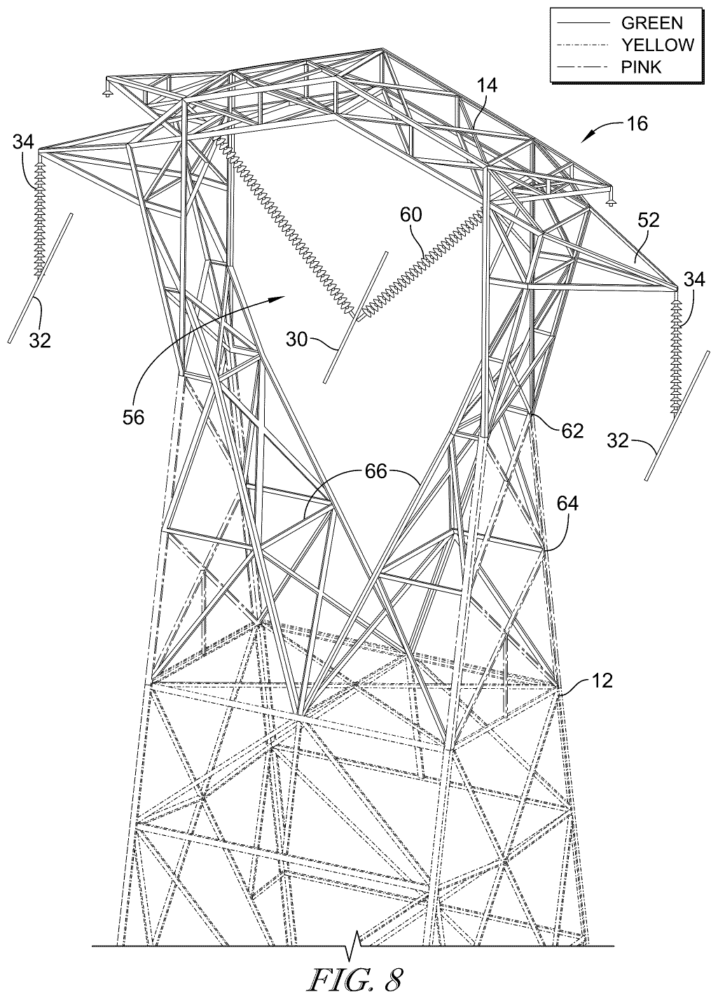

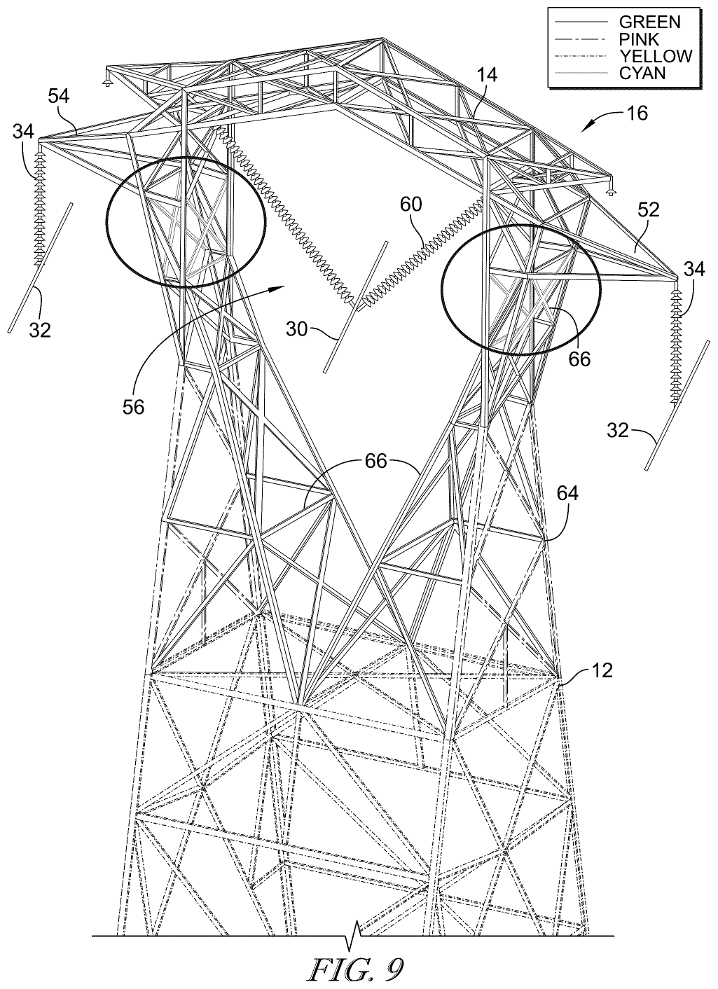

FIG. 7 is a perspective view of the upgraded tower 16 showing the outer conductors 32 being moved from the wing ends 58 of the original cross arm 24 to the new arms 52 of the new tower top 14. FIG. 8 shows the step of removing the remaining wing ends 58 of the original cross arm 24 from the tower 12. FIG. 9 shows the step of installing exoskeleton bracing 66 adjacent the new arms 52, 54 for the outer circuits 32 shown in the circled areas. FIG. 10 is a perspective view of the upgraded tower 16 showing increased phase to tower spacing, and height increase for phase to ground clearance betterment and ready for installation of double or triple conductor phases for upgraded utility capacity.

The proposed system and method is used in connection with existing transmission line routes. The circuit multiplier “NRG-x” adds a new tower top 14 to an existing transmission structure 12 to increase overall line capacity without the need for using new right of ways and completely new towers. The system and method converts existing high-voltage single circuit transmission line (corridor/path) to double or triple circuit phases. The upgraded tower 16 would elevate the circuits as much as an additional five feet or more above the ground for phase to ground betterment.

The existing circuit can also be upgraded to higher voltage. As an example, an existing 230 kV circuit could be re-equipped with a higher voltage of 345 kV or 500 kV.

The system and method uses existing transmission line and structural support as well as the existing foundation footprint. The system adds a structural exoskeleton 20 “ExoSKEL™” that is added to the tower 12 to support the loading of the new tower top 14. The system uses the existing transmission tower structure 18 and foundation 22 to install a new structural exoskeleton 20 around the existing tower structure 18 and attaching the exoskeleton 20 to the existing and or an upgraded foundation 22 allows utilities to significantly improve the capacity on the transmission lines without acquiring new right-of-ways. The new structural exoskeleton 20 is used to support the new tower top 14 that replaces the original cross arm 24 of the tower 12.

As part of installing the exoskeleton, the existing tower structure 18 can be used as rigging and mounting supports for construction to install the external structural exoskeleton 20 to the existing tower 12. The additional structural exoskeleton 20 supports transfer the additional loads created by the new tower top 14 into the existing foundation 22 or the upgraded foundation. The exoskeleton 20 includes framing members 26 that are secured to the existing tower framing members by the use of fasteners or welding. If an upgraded foundation is added, it may include a variety of foundation upgrade capacity methods such as increased foundation diameter, concrete encasements, upgraded or new tower leg abutment attachment points, installation of helical pile systems, installation of new driven or poured in place piles, all of which would be integrated into/with the existing tower foundation for the exoskeleton 20 to be secured to.

Depending on the condition of the original footings, the existing tower foundations 22 may need to be upgraded to provide support for the new tower top 14. Foundation upgrades can be integrated into the existing disturbed area of the original foundation footprint, thus removing the requirements for new right of way easements and allowances. Using the existing tower structure 18 as a rigging and mounting support system, this allows the utilities to install most of the structural exoskeleton framing members 20 of the present disclosure (>50%) without requiring a power outage, thus saving significant outage costs during tower upgrade construction. The present system also reduces the required amount of large cranes at the site thus reducing the environmental impact during construction.

Tower top section circuit upgrades are developed project to project and depend on the types of existing towers 12 used and the foundations 22 supporting the towers. The exoskeleton 20 includes the installation of various HSS & angle iron members and splice and stitch members or other structural steel to the existing structure. The system increases the capacity of existing tower legs by reinforcing them through the attachment of additional HSS & angle members parallel to the existing legs from the base upward. The exoskeleton reinforcing members are connected corner-to-corner to the existing legs by bolted connections. The exoskeleton 20 carries forces from the new tower top 14 to the foundation 20 to reduce the load on the existing structure 12.

The method of designing and installing the system upgrades to an existing tower 12 requires several phases. These phases include the feasibility study phase, the condition assessment phase, and the detailed design and analysis phase.

The project feasibility study phase is the first phase in the method of the present disclosure. The project feasibility study phase requires the evaluation and analysis of existing tower configurations to determine the applicability for adding a new tower top section 14 to the existing towers 12. This phase includes evaluation of transmission line upgrade needs and determining voltage requirements for additional overhead circuits. Voltage requirement will dictate the geometry of the additional overhead circuit, conductor type, bundle configuration, phase configuration (horizontal/delta), horizontal and vertical phase spacing. The project feasibility study phase includes preliminary as built and upgrade analysis models of the structures to determine high-level feasibility of the upgrade.

Next, the method involves the conditional assessment phase of the actual tower structures. This phase involves field evaluation focusing on the condition of the existing structures. Generally conducted as a ground based visual inspection of the super-structure to evaluate requirements for structural maintenance and repairs that may need to be incorporated into the detailed design phase. Depending on the availability of as-built information and drawings, a climbing inspection may be required to gather detailed as-built information.

Next, the method involves the foundation condition assessment. The foundation condition assessment is a field evaluation focusing on the groundline and transitional zone (shallow excavations) of the existing foundations, including maintenance and repairs that may need to be incorporated into the detailed design phase. As with the super-structure of the tower, depending on availability of as-built information/drawings select foundations may need to be exposed (daylighting) to gather detailed as-built information. Geotechnical exploration and borehole logs may be required to gather needed information to make a proper assessment on foundation condition and capacity.

Next, the method involves the detailed design and analysis phase. The detailed design and analysis phase builds on the feasibility study and condition assessment phases. This phase involves the detailed design of the new tower top 14 configuration and geometry for each applicable tower type, integration of the new tower top 14 into the existing structure, and detailed design of upgrades of the existing structures and foundations, including the inclusion of an exoskeleton 20 and upgraded foundation. The new tower top 14 configuration involves integration of new tower top 14 into existing tower structure. The phase also includes developing the exoskeleton 20 for the existing tower 12, including the development of the new tower top 14. Also the phase includes the addition of other structural sections as appropriate, such as additional T-Section, Channel, and W-Section, plates.

The detailed design and analysis phase next includes necessary upgrades of the existing structures 12 and foundations 22. Structure upgrades may include tower leg reinforcements, cruciform leg sections, tower panel upgrades, member and bolted connection replacement to upgrade capacity. Foundation upgrades may also include bearing, uplift, shear upgrades, foundation bypass, or shared loading configurations, earth strengthen, and site grading.

Detailed design involves specialty transmission line and structure analysis software, combined FEA (Stress/Strain Analysis, and Nodal Analysis), 3D CAD modelling of the components, integration and structure and foundation upgrades. Complete construction and methodology drawings are produced during the detailed design phase.

The method next includes the construction and integration phase. This phase includes initial tower 12 and foundation reinforcement. Tower and foundation reinforcement can often be completed without de-energizing existing circuits providing cost savings on lost revenue due to long-term outages. Existing line remains intact and in-service to maintain system redundancy and reliability during this phase of construction. The construction and integration phase includes the installation of the new tower top 14.

The pre-assembled new tower top 14 (angle lattice, pipe frame, tubular) is installed by lifting it onto the existing tower structure 18 at where the original cross arm 24 is located. This installation can be accomplished by use of either a crane or helicopter. Next, installation of hardware and conductor of the new circuits is installed including transmission line hardware (insulators, yokes, shoes, and other components). Next, the new conductor circuit is strung and clipped into design sag. Relocation of existing or installation of new overhead ground wire (OHGW) or optical ground wire (OPGW) (if required) is next strung and clipped into design sag. Next, there is commissioning of the new transmission circuits and energization of the new transmission circuits.

The present system and method allows for increased high-voltage transmission capacity of existing transmission lines. It allows for re-using existing rights-of-way, and reusing existing tower structures, foundations and other infrastructure. The system and method also reduce the amount of material required for structures, foundation, and infrastructure compared to building new similar capacity transmission systems. The system also reduces permitting requirements and environmental impacts associated with new construction development and reduces outage time compared to wholesale structure replacement and capacity increases. The present system and method expedites integration of gen-tie and renewable energy development and is a sustainable upgrade solution with three times or greater power upgrade on existing rights of way.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A method for upgrading the capacity of an existing transmission tower having a foundation, a lattice frame, a cross arm, a tower window and existing conductors the method comprising:
adding a new tower top to the transmission tower, the tower top having structure positioned above the cross arm;
adding an exoskeleton structure to the lattice frame to transfer forces from the tower top to the foundation;
temporarily uncoupling the existing conductors from and removing the cross arm;
securing the existing conductors to the tower top; and
wherein forces created by the tower top circuit are transmitted through the exoskeleton structure and to the foundation and
wherein portions of the exoskeleton structure can be added to the existing transmission tower without deenergizing the existing electrical circuits.

2. The method of claim 1 further comprising using the utility tower to attach rigging and mounting to the utility tower to permit installing the new tower top and remove the cross arm.

3. The method of claim 1, wherein the exoskeleton structure extends from the new tower top to the foundation.

4. The method of claim 13, wherein the installation of the new tower top increases the dimensions of the tower window.

5. A method of additional circuit capacity to a utility grid having a series of utility towers each having a foundation, a lattice frame, a cross arm, a tower window and existing conductors the method comprising:
evaluating existing tower configurations to determine the applicability of adding additional circuits to the existing towers;
evaluating of transmission line upgrade requirements and determining voltage requirements for additional overhead circuits;
conducting field evaluation to determine the condition of the existing towers and foundations;
installing tower tops, removing existing tower cross arms, and adding exoskeletons to the towers based on information obtained from evaluating tower configurations, transmission line upgrade requirements, voltage requirements and the condition of existing towers and foundations to increase circuit capacity of the utility grid.

6. The method of claim 5 further including the step of installing new transmission lines and transmission line hardware to the new tower tops.

7. The method of claim 5 further including installing new or upgraded foundation supports for the towers.

8. An electrical utility upgrade system for an existing transmission tower having a foundation, a tower structure having cross arm, a lattice-type frame, and a plurality of electrical conductors, the system comprising:
a tower top section capable of supporting electrical conductors secured to the tower structure, a portion of the tower top section positioned above the cross arm;
an exoskeleton structure coupled to the frame of the tower structure;
transmission line hardware coupled to the top tower section; and
wherein forces exerted on the top tower section are transferred through the exoskeleton structure and to the foundation of the transmission tower to reduce forces acting on the tower structure.

9. The electrical utility system of claim 8, wherein the exoskeleton includes exoskeleton framing members that are secured to existing tower framing members of the tower structure.

10. The electrical utility system of claim 9, wherein the exoskeleton framing members are secured to the lower portion of the tower structure by fasteners or welding.

11. The electrical utility system of claim 9, wherein the exoskeleton structure includes framing members are secured to the foundation of the existing transmission tower.

12. The electrical utility system of claim 9, further including an enhanced foundation comprising foundation members, concrete encasements, helical piles, or poured in place piles.

13. The electrical utility system of claim 9, wherein the exoskeleton framing members comprise angle members, tubular members, or a combination of angle members and tubular members that are secured to the tower structure.

14. The electrical utility system of claim 13, further including splice and stitch members configured to secure the exoskeleton framing members to the tower structure.

15. The electrical utility system of claim 9, wherein the exoskeleton framing members extend from the foundation to the tower top section.

16. The electrical utility system of claim 8, further including rigging and mounting supports that are configured to be temporary secured to the tower structure to permit connection of the exoskeleton structure to be attached to the tower structure.

17. The electrical utility system of claim 8, further including one or more receiving brackets to permit the tower top section to be secured to the tower structure.

18. The electrical utility system of claim 8, wherein the tower top section is configured as a multiple circuit configuration.

19. The electrical utility system of claim 8, wherein the top tower section includes a series of insulators.

20. The electrical utility system of claim 8, wherein the top tower section forms part of a window in the tower structure.
